(19) United States
(12) Patent Application Publication
(10) Pub. No.: US 2026/0276448 A1
(43) Pub. Date: Sep. 17, 2026

(54) STANDOFF SENSOR FOR INDUSTRIAL FLARES AND WILDFIRES

(71) Applicant: The George Washington University, Washington, DC (US)

(72) Inventors: J. Houston Miller, Nellysfords, VA (US); Erin McCaughey, Washington, DC (US)

(73) Assignee: The George Washington University, Washington, DC (US)

(21) Appl. No.: 19/383,876

(22) Filed: Nov. 10, 2025

Related U.S. Application Data
(60) Provisional application No. 63/718,044, filed on Nov. 8, 2024.

(51) Int. Cl. G01J 5/00; G01J 5/0821

(52) U.S. Cl. CPC G01J 5/0018; G01J 5/0821

(57) ABSTRACT

A passive laser device detects a fire. The device includes a near-infrared and mid-infrared sensor configured to detect near-infrared light emission signals from a fire source. A processing device receives two near-infrared light emissions detected by said near-infrared sensor, determines an intensity ratio of the two near-infrared light emission signals, and determines a temperature of the fire source based on the intensity ratio.

### RELATED APPLICATION

The present application claims priority to U.S. Provisional Application No. 63/718,044, filed Nov. 8, 2024, the entire contents of which are hereby incorporated by reference.

### GOVERNMENT LICENSE RIGHTS

This invention was made with Government support under Grant/Contract No. NSF-CBET-2412623 awarded by the National Science Foundation. The Government has certain rights in this invention.

### BACKGROUND

This invention is focused on developing and demonstrating applications for a standoff, laser-based, fire radiometer. Instruments developed will address data deficiencies for two challenging problems associated with energy production and climate change. Wildfires, as a response to and a cause of climate warming, are an increasing global threat. The total burned area during “fire seasons” has gone from ~1000 square miles prior to 2000 to over ~2500 square miles in the last 20 years. NASA's FireSense program emphasizes real-time observation and characterization of wildfires as a priority focus. However, satellite characterization of fires is limited by daylight, clouds, spectral, spatial, and temporal resolution. Thus, a clear need exists for “ground truthing” that can fill in data voids and provide real-time data to first responders. A second “use case” for this technology is in the characterization of industrial flares. As with wildfires, satellite measurements of emitted light do not explicitly provide chemical information, such as amounts of unburnt fuel or concentrations of higher molecular weight compounds. Satellite measurements are possible only at night when sunlight does not overwhelm thermal emission signatures and can be obscured by clouds.

The following prior art is fully incorporated by reference herewith: U.S. Pat. No. 8,369,567B1: A method for detecting and mapping fires using features extracted from overhead imagery. WO2006012585A2: An infrared fire detection sensor and method. US20140371672A1: A system for detecting and extinguishing wildfires using infrared sensors. US20230258559. U.S. Pat. No. 5,252,060 for Infrared Laser Fault Detection Method for Hazardous Waste Incineration (specifically relevant to the use of carbon monoxide as a surrogate for other emissions).

### Natural Gas Flares

Although there has been momentum in transitioning to cleaner/greener energy sources, fossil fuels will be needed for decades to come, both as a direct fuel source and as a transition source, such as generation of “green” hydrogen from methane. An unfortunate aspect of both extraction and refining of fossil fuels, is the excess methane liberated and produced in the process, at locations which lack infrastructure to capture this fuel. Since methane's global warming potential is ~25x that of CO₂, the strategy has been to burn off the hydrocarbons as the lesser of evils. However, uncontrolled or unoptimized flaring of methane often leads to incomplete combustion producing nonideal emissions of mixed greenhouse gases as well as volatile organic compounds (VOCs).

According to the World Bank: “Thousands of gas flares at oil production sites worldwide burned approximately 144 billion cubic meters of gas in 2021. Assuming a ‘typical’ associated gas composition, a flare combustion efficiency of 98% and a Global Warming Potential for methane of 25, each cubic meter of associated gas flared results in about 2.8 kilograms of CO₂ equivalent emissions, resulting in over 400 million tons of CO₂ equivalent emissions annually. The methane emissions resulting from the inefficiency of the flare combustion contribute significantly to global warming.”

There is a worldwide push to end flaring, but the practice continues. The 144 billion m³ of methane flared in 2021 could have generated about two-thirds of Europe's net electricity needs. When differences in global warming potential are factored into the 2021 data, unburnt methane increases flare global warming CO₂ equivalents by 11%.

Thus, the need exists for flare remote sensing methods that are improvements over satellite monitoring, ground-mounted thermal imagers, and stack-mounted chemical sensors. Satellites and ground-mounted thermal imagers respond primarily to blackbody emissions from soot within flares. As will be shown here, molecular emissions may be used to determine flame temperatures, noting that combustion gas temperatures on the order of 2000 K may be significantly higher than indicated by blackbody radiation from particulates that are on the order of 1700 K.

### Sensing Wildfires

The most damaging fires are dominated by high-intensity crown fires. Radiant Energy flux from crown fires is in the range of several hundred KW/m² with temperatures observed up to 1200° C. (~1500 K) with onset rates of on the order of tens® C./s. Fire radiative power (FRP) is a measure of the radiation from a fire, summing contributions from the full spectrum of emission. By and large this quantity is measured from space including the EU's Sentinel-3A and -3B satellites and NASA/NOAA MODIS (Thermal Anomalies and Fire Products). FRP correlates well with fuel mass loss and fire emission concentrations, and is critically important in estimating fire spread and informing effective and safe fire-fighting procedures. However, satellite data is not always available due to weather conditions and the algorithms for the analysis of nighttime data is more advanced than that for daytime measurements limiting temporal resolution. Further, satellite orbits neither provide good spatial or temporal resolution. Alternatives to space-based measurements using radar are emerging but radar may be compromised by ground clutter, topography, and anomalous propagation.

The dramatic rate in increase in wildfire severity and economic impact over the past decades has led to increased effort in their detection. Much of the technology deployed has been space-based and newer missions focus on hyperspectral imaging consisting of 10-100s of narrow spectral bands (each less than 20 nm) rather than multispectral imaging that feature fewer and wider spectral bands. Sensors have largely been focused on visible and shortwave infrared (VSWIR) wavelengths and have been designed to span the entire life cycle of a fire from pre-fire (analysis of fuel loading and moisture content), active fire (including analysis of severity and fire-spread parameterization), and post fire (to examine burn-extent and recovery of the ecosystem).

Both the US and the EU have satellite platforms that may be used to detect fires. In collaboration with NOAA, NASA maintains two systems launched in 1999 and 2002 (Moderate Resolution Imaging Spectroradiometer-MODIS) and a newer system launched in 2011 (the Visible Infrared Imaging Radiometer Suite-VIIRS). Each contains spectrometers centered on a number of wavelength bands. For VIIRS, fire detection focuses on band M13 centered at 4.05 μm with a FWHM of 0.155 μm because of its sensitivity to molecular emission from hot carbon dioxide. In addition, blackbody emission from hot fire particulate closer to 2000 K peaks in the near infrared (NIR) which aligns with bands M7, M8, and M10 at 0.865, 1.24, and 1.61 μm, respectively. Smoldering fires are cooler resulting in lower blackbody emission power and a shift in peak to longer wavelengths. The amount of solar radiation at the top of the atmosphere is often modelled as a ~5500 K blackbody which results in a shift to lower wavelengths of the peak emission, but greater radiative power. Spanning the NIR and MIR bands highlighted above, this radiation may dominate both thermal emission from fire particulate as well as atomic and molecular radiative emissions.

An exception to the observation of the dominance of blackbody over atomic and molecular emission has been explored in several manuscripts and reviews. Biofuels contain trace elements, including potassium which is present at the single digit mass percentage range and has a relatively modest ionization potential of 4.32 eV. These elements are typically present in biomass as ionic compounds (halides for example) and potassium is almost universally found in wildfire particulates. Alkali metals have strong spectral emission doublets that are populated at elevated temperatures through recombination processes of ions. For potassium the ²P_{3/2}-²S_{1/2} and ²P_{1/2}-²S_{1/2} lines occur at 766.5 and 769.9 nm (~1.6 eV) and are observable above broadband thermal radiation in fires. The magnitude of the spectral emission is governed by the population of the excited state which can be determined through the Saha equation. For potassium, there is essentially no ionization and thus no emission until the temperature reaches several hundred® C.; thus smouldering fires cannot be observed, but flaming fires can. Thus, potassium spectral emission offers a diagnostic that is specific to flaming biofueled fires.

### Laser Heterodyne Radiometry

Optical heterodyne methods are similar to their electronic counterparts used in radio and television, among other applications. Incoming light is combined with light from a narrow-band laser source (the local oscillator or LO) on a photodetector. Historically, most applications of LHR have focused on solar occultation spectroscopy and its development has tracked the availability of (and improvements in) low-noise laser sources and detectors. The earliest work, nearly all from NASA's Jet Propulsion Laboratory, began in the mid-1970's used CO₂ lasers to detect O₃, SO₂, NH₃, ethylene and NO. Implementations included balloon-borne instruments, greater wavelength coverage and, with it, increased numbers of gases that could be detected, followed beginning ~1998 when lead-salt diode lasers were used as local oscillators, although detection sensitivity was constrained by the need for complicated optical designs used to reduce excess noise. Development of quantum cascade lasers led to improved mid-infrared LHR with much of the work reported by Weidmann and colleagues

On O₃, N₂O, CH₄, CCl₂F₂, and H₂O. The detector output will contain AC electronic signals at the (optical) difference frequencies. Heterodyne signals are proportional to the solar spectrum at the LO wavelength. When the LO coincides with an optical absorbance, the heterodyne signal intensity will drop by an amount proportional to the absorbance.

### Laser Heterodyne Radiometry of Flames and Fire

Nearly twenty years ago, Weidmann suggested the use of laser heterodyne radiometry as a combustion diagnostic by investigating water vapor in a methane/air premixed flame using a 7.6 μm (~1305 cm⁻¹) lead-salt laser as the local oscillator relying on similar mixing technologies as done in the pioneering work of Menzies et al. decades earlier. The laser used in this work was far from ideal. It is a Fabry-Perot source thus requiring mode selection (typically done with a monochromator which limits power to that carried in a single longitudinal mode). Lead salt lasers' cw power is low and of poor spectral purity (10-100 MHz linewidths). Moreover, mid infrared detectors (and their preamplifiers) available at that time had very modest bandwidths thus limiting integrated rf power. In a subsequent paper, Weidmann postulated that the power and improved spectral properties of the then just-emerging Quantum Cascade Lasers would overcome these technical obstacles and make LHR a practical combustion diagnostic even for standoff applications. As far as we have been able to determine, these are the only published applications of LHR to a combustion source and both focused on absorption rather than molecular emission spectroscopy.

The GW Laser Analytics group (GWLAG) has participated in the development of Laser Heterodyne Radiometry (LHR) instruments in conjunction with NASA Goddard and more recently through a partnership with Mesa Photonics, with funding through a DoE STTR Phase II grant. Our LHR work includes both aspects of instrument design and control and retrieval of species concentrations from measured column spectra. In our prior LHR data campaigns, the retrieval algorithm developed at GWU, known as LahetraSim converts the scanned absorption feature to a vertically-resolved mixing ratios. Specifically, molecular absorption cross sections are calculated for each spectral window at 0.001 cm-1 resolution for every combination of atmospheric pressure and temperature at 1 mbar and 1 K resolutions, respectively. (from 1 to 1100 mbar and 200 to 310 K). These simulations are done using the HITRAN Application Programming Interface (HAPI) using the partially Correlated quadratic-Speed-Dependent HardCollision profile (pCqSDHCP) model data when available. Data are stored in indexed, binary files for subsequent near real-time retrievals.

In this algorithm, the atmosphere is modelled as a series of spherically symmetric shells with boundaries specified at defined altitudes. Pressure and temperature profiles have been estimated throughout the troposphere and mid-low stratosphere by inputting location and time-date data from the Planetary Spectrum Generator and MERRA-2 or from historic radiosonde data. Spectra calculated for 100 m steps from ground level to the mid stratosphere are co-added. The resultant spectra were then fit using a Nelder-Mead simplex algorithm iterating on gas concentration within each altitude layer.

Precision heterodyne oxygen-corrected spectroscopy (PHOCS), a name coined by Mesa Photonics in an earlier prior NASA-supported SBIR project, adds a heterodyne channel to the electronics that monitors oxygen absorption. As the oxygen mixing ratio is nearly constant through the troposphere and stratosphere, its line shape may be interrogated to refine pressure and temperature profiles drawn from other sources.

Fire (atomic and molecular) emission spectroscopy and preliminary results. Approximately 3 decades ago, William Grosshandler (of the US National Institute of Standards and Technology) presented a seminal work on Flame Radiation modelling in the form of the software package RADCAL. In the ensuing years, this code and its ancestors have become the standard tool for modelling thermal radiation in numerous manuscripts as well as recommended code for use in both the International Workshop on Measurement and Computation of Turbulent Flames (TNF) and the International Sooting Flame Workshop. Online computational tools exist for modelling both blackbody and molecular emissions from hot sources.

### SUMMARY

A passive laser device detects a fire. The device includes a near-infrared sensor configured to detect near-infrared light emission signals from a fire source. The sensor receives two near-infrared light emissions, determines an intensity ratio of the two near-infrared light emission signals, and determines a temperature of the fire source based on the intensity ratio. A sensor receives near-infrared light emissions and determines the concentration of potassium within the fire. A second device includes a mid-infrared sensor configured to detect mid-infrared light emissions from a fire source. The sensor receives mid-infrared light emissions, determines temperatures and concentration of hot gasses, and determines the combustion efficiency of the fire source based on the concentration of hot gasses.

These and other objects of the disclosure, as well as many of the intended advantages thereof, will become more readily apparent when reference is made to the following description, taken in conjunction with the accompanying drawings.

### BRIEF DESCRIPTION OF THE DRAWINGS

The accompanying drawings are incorporated in and constitute a part of this specification. It is to be understood that the drawings illustrate only some examples of the disclosure and other examples or combinations of various examples that are not specifically illustrated in the figures may still fall within the scope of this disclosure. Examples will now be described with additional detail through the use of the drawings, in which:

FIG. 1 is a block diagram of a fiber-optic based LHR sensor;

FIG. 2 is a diagram of a free space LHR sensor;

FIG. 3A is a diagram showing spectral resolution in LHR measurements;

FIG. 3B is a diagram showing representative CO₂ absorbance data;

FIGS. 4A, 4B are diagrams showing FTIR spectra of flame emission;

FIG. 4C is a diagram showing simulated Lahetra spectrum;

FIG. 4D is a diagram showing molecular radiative emission; and

FIG. 5 is a field-deployable system.

### DETAILED DESCRIPTION

In describing the illustrative, non-limiting preferred embodiments of the invention illustrated in the drawings, specific terminology will be resorted to for the sake of clarity. However, the invention is not intended to be limited to the specific terms so selected, and it is to be understood that each specific term includes all technical equivalents that operate in similar manner to accomplish a similar purpose. Several embodiments of the invention are described for illustrative purposes, it being understood that the invention may be embodied in other forms not specifically shown in the drawings.

This present disclosure is focused on developing and demonstrating new applications for a passive laser diagnostic: thermal emission laser heterodyne radiometry (TE-LHR). As used here, passive refers to the fact that laser radiation does not enter the environment and thus poses no risk to the public. LHR has been a rapidly growing tool in atmospheric measurements but has seen only a brief mention as a potential combustion/fire diagnostic. The primary focus of this system will be on remote detection and characterization of wildfires. However, an additional application space for this work will be in the physical characterization and pollutant emission analysis from natural gas flares. In contrast to applications in atmospheric sensing that are based on solar occultation, this proposal focuses on radiometry of atomic and molecular spectral emissions leading to measurements of temperature, composition, combustion efficiency as well as downstream spectral absorption of fire effluents.

We describe two laser heterodyne radiometers. The first system will operate in the near infrared and will focus on potassium detection. (Potassium light emission is a characteristic of only intense fires of plant materials and not fossil fuels.) The second system operates in the mid infrared, electromagnetic spectral region, here defined as light with wavelength exceeding 2.5 μm. In a first instance, a detection unit will be constructed for operation at ~2200 cm⁻¹ (~4.545 μm) for the detection of both carbon monoxide and carbon dioxide radiative emissions. This sensor is expected to provide directly flame temperature as well as a measure of combustion efficiency.

In both biomass burning (wildfire) and industrial flare emission characterization, a primary performance metric derived from CO and CO₂ concentrations is the Modified Combustion Efficiency (MCE):

$$MCE = \frac{Δ {CO}_{2}}{Δ {CO}_{2} + Δ CO}$$

Where Δ denotes the measured concentration above background levels.

MCE is a widely used proxy for the relative amount of flaming versus smoldering combustion:

High MCE (≈0.95 to 0.99): Indicates flaming combustion, which is hot, clean, and highly efficient at converting carbon in the fuel to CO₂.

Low MCE (≈0.65 to $0.85): Indicates smoldering combustion, which is slow, cool, and produces a large amount of incomplete combustion products like CO, CH₄, and particulate matter.

MCE Correlates with Other Emissions: Experimental data shows a strong correlation between MCE and the Emission Factors (EFs) for almost all other trace gases and aerosols. This means MCE effectively characterizes the chemistry of the plume.

In a second iteration of a mid-infrared device, a source close to 2780 cm⁻¹ (~3.6 μm) will be used to explore radiative emissions from methane.

This invention is a new a passive laser diagnostic: thermal emission laser heterodyne radiometry (TE-LHR). Laser Heterodyne Radiometry (LHR) has been a rapidly growing tool in atmospheric measurements but has seen only a brief mention as a potential combustion/fire diagnostic. Optical heterodyne methods are like their electronic counterparts used in radio and television, among other applications. Incoming light is combined with light from a narrow-band laser source (the local oscillator or LO) on a photodetector. Historically, most applications of LHR have focused on solar occultation spectroscopy and its development has tracked the availability of (and improvements in) low-noise laser sources and detectors. This instrument would apply the same technology to light emissions from hot sources (through the analysis of spectral signatures from atomic ions, molecules, and flame particulate.)

Two use cases for the technology focus are remote detection and characterization of wildfires and the physical characterization and pollutant emission analysis from natural gas flares. Specifically, detection of potassium radiative emission from wildfires and radiative emission from molecular emissions from dominant flame species (carbon monoxide, carbon dioxide, and water) will be possible. Potassium light emission is unique to hot fires from biofuels. The molecular spectral emissions can be used to characterize flame temperature and combustion efficiency. Broadband particle emission serves as hyperspectral light emissions source for subsequent atmospheric absorption that would reveal pollutant emissions from the fire. However, this diagnostic would be applicable to ANY combustion source, either intentional or unintentional.

Fire radiative power (FRP) is a measure of the radiation from a fire, summing contributions from the full spectrum of emission. By and large this quantity is measured from space including the EU's Sentinel-3A and -3B satellites and NASA/NOAA MODIS (Thermal Anomalies and Fire Products). FRP correlates well with fuel mass loss and fire emission concentration and is critically important in estimating fire spread and informing effective and safe fire-fighting procedures. Satellite characterization of fires is limited by daylight, clouds, spectral, spatial, and temporal resolution. Thus, a clear need for “ground truthing” that can fill in data voids and provide real-time data to first responders. Alternatives to space-based measurements using radar are emerging but radar may be compromised by ground clutter, topography, and anomalous propagation.

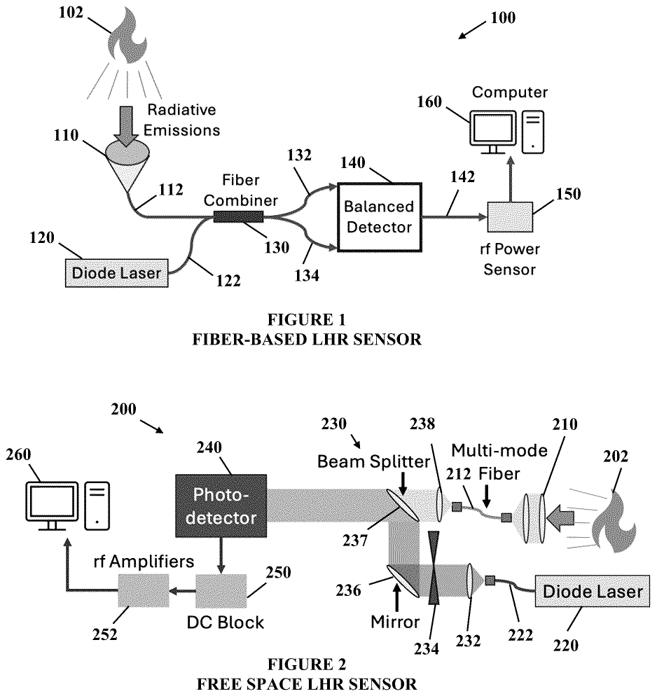

### Fiber-Based LHR Sensor 100 (FIG. 1)

Referring to the drawings, FIG. 1 shows a fiber-based LHR sensor system 100 in accordance with an example illustrative embodiment of the present disclosure. The LHR sensor system 100 includes a sensor having one or more collection optics 110, diode laser 120, fiber combiner 130, balanced detector 140, radio frequency (RF) power sensor 150, and processing device 160, such as a processor or computer. The sensor system 100 can operate as a radiometer, for example a radiometer that detects potassium as noted above.

As illustrated, the collection optics 110 focus the radiative emissions from a fire source 102. The collection optics 110 may include one or more of a lens, mirror, or fiber coupled collimating system that are configured to focus incident broadband light from the flame source 102 into an optical fiber input 112. The collection optics 110 function as a passive receiver, and they do not emit or project any radiation, and instead collect and spatially couple light from a remote source into a guided optical path. The optical fiber 112 is a single mode fiber that transmits the collected optical signal from the collection optics 110 to a fiber combiner 130. At the same time, the diode laser 120 generates a laser signal output that serves as a local oscillator for heterodyne detection. The laser output is coupled into a second optical fiber 122 that delivers the signal from the diode laser 120 to the optical fiber combiner 130.

The optical combiner 130 has two legs for input and two legs for output. The first combiner leg 112 has a first end collecting to the radiative emissions received by the optics 110, and a second opposite end coupled to the fiber combiner 130; and the second fiber 122 has a first end coupled to the diode laser 120, and a second opposite end coupled to the fiber combiner 130. The fiber combiner 130 receives both the broadband optical signal from the collection optics 110 via the first fiber 112 and the narrowband laser output from the diode laser 120 via the second fiber 122. The fiber combiner 130 optically mixes the two signals by superimposing them in the same spatial mode. The light mixes (combines) via this fiber combiner to create a beat note, which is an interference pattern produced when two optical fields of different frequencies are combined. This beat note, also known as the heterodyne signal, is used to translate the optical frequency domain information (on the order of hundreds of terahertz) into an electronic frequency range (on the order of megahertz to gigahertz) that can be measured using photodetectors and RF electronics. The fiber combiner 130 has a first output fiber 132, and a second output fiber 134. The output fibers 132 and 134 carry the combined optical signals. Each output carries an identical mixed optical signal from the fiber combiner 130 with a fixed phase relationship. The two outputs of the fiber combiner 130 (fibers 132 and 134) produce optical signals that are phase-shifted approximately 180 degrees relative to each other, which is defined by the coupler geometry, such that the first output 132 is equal to but opposite of the second output 134.

The first end of the first output fiber 132 is coupled to the output of the fiber combiner 130, and the second opposite end of the first output fiber 132 is coupled to a first input of the balanced detector 140. In addition, the first end of the second output fiber 134 is coupled to the output of the fiber combiner 130, and the second opposite end of the second output fiber 134 is coupled to a second input of the balanced detector 140. The balanced detector 140 to converts optical power on each input into electric signal, which can be measured, digitized and processed.

The balanced detector 140 subtracts the two input photocurrents (from 132, 134) to remove common-mode noise and extract the heterodyne beat signal that results from interference between the broadband emission and the laser diode reference. Any optical or electrical noise that appear identical on both channels (common-mode noise) is removed through this subtraction, which isolates the heterodyne beat signal. The electrical output of the balanced detector 140 is therefore a radio-frequency (RF) signal whose amplitude and spectrum contains information about the spectral characteristics of the radiative source emission 102 near the laser diode 120 frequency. The output of the balanced detector 140 is transmitted from the balanced detector 140 to the RF power sensor 150, such as on line 142.

The RF power sensor 150 measures the power of the beat signal within a defined frequency band. The RF power sensor 150 outputs an electrical signal proportional to the detected RF power output from the balanced detector 140. The output of the RF power sensor is in communication with a computer 160, which records, analyses, and displays measured spectra. The sensor 150 can be located at the computer 160 or can transmit the sensed output to the computer 160.

Because no laser radiation exits the system towards the environment, and the laser output remains confined entirely within the optical fibers, the configuration is considered passive. It is also a standoff measurement system, as the collection optics 110 capture naturally emitted thermal radiation from the remote fire source 102 at a distance, without requiring physical contact or intrusive probing.

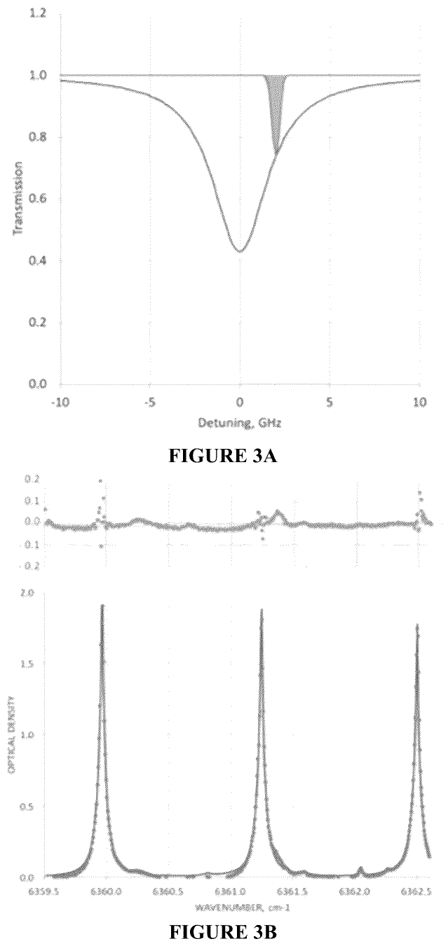

### Free-Space LHR Sensor 200 (FIG. 2)

FIG. 2 shows a free-space LHR sensor system 200 in accordance with an example illustrative embodiment of the present disclosure. The system 200 includes collection optics 210, diode laser 220, an optical combiner assembly 230, photodetector 240, DC block 250, amplifiers 252, and computing device 260. In this embodiment, the radiative emission and a coherent laser reference beam are combined in free space (i.e., at the optical combiner assembly 230) rather than within an optical fiber (as in FIG. 1). The sensor system 200 can operate as a radiometer, for example a radiometer that detects potassium or mid-infrared, as noted above.

The optical combiner assembly 230 includes one or more optical components to combine the light from the source 202 and the light from the diode laser 220. In the example embodiment shown, the optical combiner assembly 230 includes a first input light collimator 238, a diode laser collimator 232, an optical chopper 234, a mirror 236, and a beam splitter 237. The first and second input light collimators can be any suitable optical component(s), shown here as a first input optical lens 238 and a second input optical lens 232, respectively.

The collection optics 210 receive broadband optical radiation emitted from the remote fire source 202. These optics 210 may include one or more lenses or mirrors configured to focus and collimate the collected light from the light (fire) source 202 onto a multimode fiber 212. The output optical signal from this multimode fiber 212 is collimated using the first input light collimator, here a first input lens 238, which guides the broadband emission towards a first side of the beam splitter 237, here an optical lens. Thus, the collection optics 210, multimode fiber 212, and collimating lens 238 collectively operate as a passive receiver of thermal radiation and provide an output optical signal which propagates to the beam splitter 230.

Simultaneously, the diode laser 220 generates a narrowband, frequency-tunable laser beam that serves as the local oscillator for heterodyne mixing. The laser output is coupled into a single mode optical fiber 222, which transmits the coherent laser light to the second input optical lens 232, here a collimating lens 232. The collimating lens 232 converts the guided light from fiber 22 into a free space collimate laser beam. The collimate laser beam passes through an optical chopper 234, which periodically interrupts the laser beam at a known reference frequency. This modulation enables synchronous detection of the heterodyne signal, supressing background noise. The chopper laser beam is re-directed using a mirror 236 towards the beam splitter 230.

The beam splitter 230 receives two optical inputs: the broadband emission beam from the radiation source 202; and the chopped, coherent laser beam from the diode laser 220. The beam splitter 230 optically combines these two inputs, superimposing the incoherent emission and the coherent laser reference to form a mixed optical field that contains the heterodyne beat signal. This heterodyne beat signal contains information about the spectral characteristics of the radiative source emission 202 near the laser diode 220 frequency.

This combined optical field from the beam splitter 230 is directed onto a photodetector 240. The photodetector 240 converts the incident optical intensity fluctuations into an electrical signal. The photodetector electrical output current contains both DC and RF components. The DC component is the steady part of the output corresponding to the average light level, which does not fluctuate with the presence of molecule of interest. The RF component corresponds to the heterodyne beat signal between the laser diode 220 frequency and components of the broadband emission 202, which contains spectral information about the molecular emission of interest.

The output of the photodetector is transmitted to a DC block 250, which removes the DC components of the signal, passing only the RF heterodyne signal. The removal of the DC component, which contains no spectral information, isolates the heterodyne beat signal, which encodes the frequency difference between the laser and the radiative emission features. The filtered RF signal is then sent through one or more RF amplifiers 252 to increase its amplitude for analysis. The amplified RF signal is received and processed by a computer 260, which records the signal power and extracts emission characteristics of the remote source 202.

The configuration of FIG. 2 is passive because the laser diode radiation does not propagate towards or illuminate the remote radiation source 202. Instead, it remains confined within the local measurement apparatus. Only naturally emitted radiation from the source is collected. The system is standoff because it measures those emissions from a remote source without requiring physical contact or invasive probing. This embodiment is termed an “open-path”LHR sensor because the optical mixing, propagation, and detection occur in free-space rather than within enclosed optical fibers.

Compared with the fiber-based LHR sensor of FIG. 1, the free space configuration of FIG. 2 offers enhanced optical throughput and easier collection of broadband emission, reduced coupling losses compared to fiber combiners, adjustable free-space alignment for optimal heterodyne overlap, and the ability to use an optical chopper for modulation and lock-in detection which improves signal discrimination against background noise.

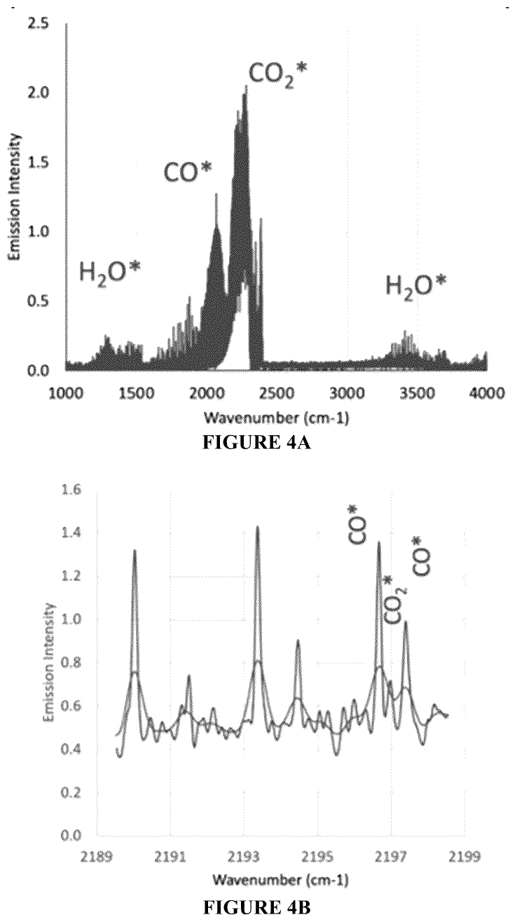

FIGS. 3-5 illustrate operational and performance aspects of the fiber-based and free-space LHR sensor systems 100, 200 of FIGS. 1, 2, respectively. However, it will be recognized that the operations discussed herein can be applied to other suitable sensors, other than those shown in FIGS. 1, 2. FIGS. 3A, 3B show results from LHR implementations developed at GWU for solar occultation, which employs the same underlying heterodyne detection principle used in fiber-based and free-space sensors of FIGS. 1 and 2. FIG. 3A is an illustration of spectral resolution in LHR measurements. The blue trace approximates the shape of an atmospheric absorption feature with a width of 0.1 cm⁻¹ (3 GHZ). The orange shaded area represents the effective resolution imposed from a 200 MHz low pass filter in the rf signal. In our work, the heterodyne signal power is monitored as the laser (local oscillator) is tuned through an absorption feature-effectively the area of the orange shaded area. FIG. 3B is representative CO₂ absorbance data collected near 1572 nm is shown in blue while a fit using the GWU LahetraSim modelling software is shown in the red trace. The gray trace at the top show residuals in the fit.

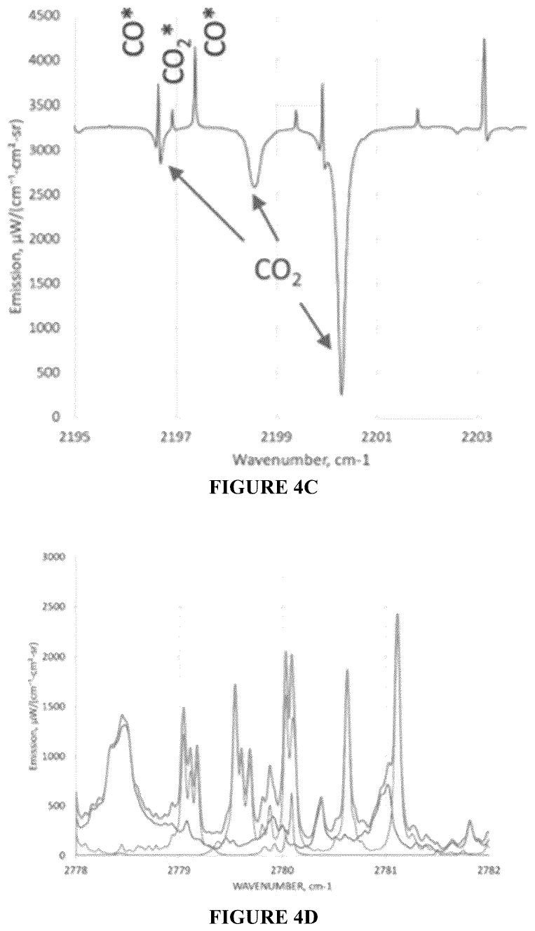

FIG. 4 presents both experimental and modelled spectra that demonstrate the capability of the laser heterodyne radiometer sensing approach described with reference to FIGS. 1 and 2. In particular, FIG. 4(a) shows a Fourier-transform infrared (FTIR) spectrum of broadband molecular radiation collected from a non-premixed 60% C₂H₄/40% N₂ flame at approximately 25 mm height above the burner (HAB). Distinct emission bands corresponding to CO*, CO₂*, H₂O, and other combustion intermediates are labeled to indicate the molecular species contributing to the measured signal. FIG. 4(b) expands a narrow spectral region near 2200 cm⁻¹, comparing high-resolution (0.125 cm⁻¹, red trace) and reduced resolution (0.5 cm⁻¹, blue trace) measurements. The ratio of selected line pairs (such as the CO* doublet indicated) can be used to determine gas temperature. However, in FTIR systems, such temperature retrieval is limited by the relatively coarse spectral resolution and the convolution of the interferometric line-shape function. FIG. 4(c) shows a simulated heterodyne spectrum of the same region generated using LahetraSim software at 0.001 cm⁻¹ resolution, representative of the spectral resolving power attainable with the fiber-based or free-space LHR configurations in FIGS. 1-2. This comparison illustrates the much finer spectral detail accessible by heterodyne detection relative to conventional FTIR approaches. FIG. 4(d) further illustrates simulated molecular emission spectra for a mixture representative of a hydrocarbon flare, consisting of 10% CH₄, 10% H₂O, and 1% H₂CO at 1700 K and 1 atm. The summed spectrum (gray) demonstrates the spectral complexity and diagnostic potential of the mid-infrared region targeted by the LHR system.

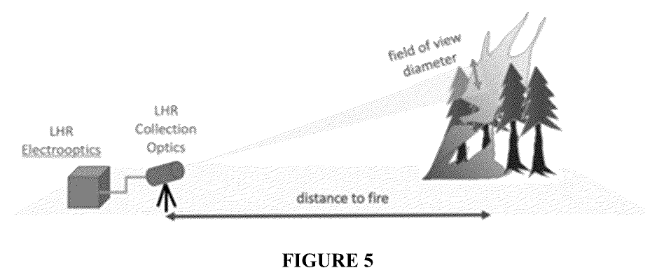

FIG. 5 shows a schematic of a representative deployment geometry for a mid-infrared or near infrared LHR system operating in a standoff configuration. Radiation from a remote source (such as a flame or flare) is collected by a telescope equipped with a collection optic functioning as an eyepiece. At a standoff distance of 1 km, this optical assembly provides a wide field of view, enabling passive monitoring of extended radiating scenes. The optical signal gathered at the telescope focus can be coupled directly into the collection optics 110 (FIG. 1) or the optical collection assembly 230 (FIG. 2).

Together, FIGS. 4 and 5 demonstrate the spectral fidelity achievable with the LHR approach and its adaptability to remote, open-path geometries, highlighting the advantages of the passive, and standoff-capable configurations introduced in FIGS. 1 and 2.

### Both Sensors 100, 200 (FIGS. 1, 2)

The sensors 100, 200 are passive laser devises, meaning that the light never leaves the instrument enclosure and are thus eye safe. The enclosure can be, for example, a sensor housing that partially or fully encloses the sensor 100, 200, or one or more of the sensor components.

Spectral resolution from the LHR sensors 100, 200 is superior to more conventional applied spectroscopy instruments that use diffraction gratings, prisms, or interferometers for light dispersion. Thes improved resolution improves selectivity and sensitivity for targeted atoms and molecules. In certain applications, the improved resolution allows for extracting additional physical data that impacts the shapes of highly resolved spectral features.

This sensing technology leverages the rapidly evolving landscape in optoelectronics resulting in rugged, field deployable, and stand-off instruments.

In some applications, careful design of the optical light collection will result in spatially resolved measurements. At the finest scale which may be appropriate in laboratories, the technique may be combined with confocal imaging optics.

### Near Infrared Sensor

Unless otherwise indicated, the discussion applies to both configurations of sensors 100 and 200. The first implementation of the sensors 100, 200 can distinguish fires of biological origin from those burning fossil fuels by monitoring light emission between a first desired wavelength (e.g., 765 nm) and a second desired wavelength (e.g., 770 nm) to measure two light emission lines from potassium. This is done, for example, by modulating the diode laser 120 to detect the desired wavelengths of the fire signal on the first optical fiber 112 within the laser diode 120 wavelength range. These light emissions are only present in biological fires, due the presence of potassium in biofuels. “Colder” fires, like smouldering fires, will not display as intense potassium emission at the first and second desired wavelengths; that is, if potassium is present in the fire signal from the fire source 102, then a threshold level of radiative emission signal will be detected at both the first and second desired wavelengths. That threshold level can vary depending on a number of factors such as, for example, the fire temperature, and potassium concentrations. This technology may be extended to other emitters in the visible and near infrared including but not limited to other alkali metals.

In potassium, the two peaks or lines (“doublet”) arise from the transition of an electron from the 4p excited state to the 4s ground state, where the 4p level is split into two sublevels due to spin-orbit interaction. Because of the difference in energy, the relative populations of the two levels depends slightly on temperature. Specifically, the intensity of each is determined as:

$${A}_{ki} {g}_{k} \cdot {e}^{- \frac{{E}_{k}}{{Tk}_{B}}}$$

where Aₖᵢ is a measure of the strength of the two lines, gₖᵢ is the degeneracy of the upper level (4 for 766.49 nm and 2 for 769.89, both determined from quantum mechanics); Ek is the energy pf the excited state (1.617 eV for 766.49 nm and 1.610 eV for 769.89 nm).

As the longer wavelength emission signal peak appears at a similar wavelength as a feature of absorption by molecular oxygen in the atmosphere (with a known and constant concentration), the ratio also provides information on the distance of the sensor from the fire source. The ratio is impacted by the distance from the fire to the observer and this offer this opportunity for “ranging”.

The passive laser device 100, 200 can operate in single wavelength detection mode (i.e., detect at a single wavelength). The near-infrared sensor 110, 210 detects a near-infrared light emission signal from the fire source 102, 202. The processing device 160, 260 is configured to: (a) receive the near-infrared light emission detected by said near-infrared sensor; (b) determine a near-infrared light emission signal intensity at a predetermined wavelength; and (c) determine a fire source type of the fire source based on the near-infrared light emission signal intensity. In particular, the processing device is configured to determine that the fire source is a biological fire when the near-infrared light emission signal intensity is above a threshold intensity and that the fire source is a fossil fuel fire when the near-infrared light emission signal intensity is below the threshold intensity.

In addition, the passive laser device 100, 200 can also operate in a dual wavelength detection mode (i.e., detect at two wavelengths). The near-infrared sensor 110, 210 detects a near-infrared light emission signal from the fire source 102, 202. The processing device 160, 260 is configured to: (a) receive the near-infrared light emission detected by said near-infrared sensor; (b) determine a first near-infrared light emission signal intensity at a first predetermined wavelength; (c) determine a second near-infrared light emission signal intensity at a second predetermined wavelength; (d) determine an intensity ratio of the first and second near-infrared light emission signal intensities; and (e) determine a characteristic of the fire source based on the intensity ratio. The characteristic is one of temperature or distance to the fire source. The temperature and distance to the fire source are directly proportional to the intensity ratio, namely the higher the intensity ratio, the higher the temperature and distance. The first and second near-infrared light emission signals indicate the presence of potassium in the near-infrared light emission signal from the fire source. It is further noted that the sensors can operate at more than two wavelengths, and that the wavelengths can be detected at a same time or different times, from a single fire source.

### Mid Infrared Sensor(s)

The following discussion applies specifically to the free-space, open-path sensor system 200 described in FIG. 2. The fiber-based configuration 100 of FIG. 1 operates in the near-infrared and visible regimes, where suitable optical fiber technology is available. However, because low-loss optical fibers, fiber combiners, and balanced detectors are not presently available for mid-infrared (MIR) wavelengths, the configuration and discussion below do not apply to FIG. 1. Unless otherwise indicated, the discussion of other optical, electronic, or computational elements is common to both systems. In addition, the sensor 200 can operate in a single wavelength detection mode or a dual wavelength detection mode, as noted above.

Mid infrared molecular light emission shows less interference from broadband radiation characteristic of both fossil fuel fires plumes and biological fires. Wildfire emissions are typically dominated by particulate blackbody radiation. Observation of several light emission features of carbon monoxide and carbon dioxide provides source information including temperature and concentration of these hot gasses; the latter may be used to determine combustion efficiency. The combination of both fine (molecule) and broadband (particulate) emission sources allows detection of light emission from hot molecular species as outlined above, but also absorption from molecules in the path between the fire and the observers. An example of this is the detection of formaldehyde emission from a poorly operating industrial flare.

Example of light emission includes simultaneous observation of light emissions from carbon monoxide (CO) and carbon dioxide (CO₂) near 4.55 μm. The relative concentrations of CO and CO₂ may be used to determine the combustion efficiency in fossil fuel fires and is important in parametrizing wildfire emissions. The ratio of molecular light emission lines can also be used to determine fire temperature. This is again related to the relative populations of quantum levels as described above. A second example is the observation of light emissions from hot methane gas (CH₄) near 3. 6 μm from both biological and fossil fuel fires. Broadband light emission from hot particulates in the fire may be absorbed at specific wavelengths in the TELHR signal that allows their identification and quantification via absorption. This technology may also be extended to other molecular targets and/or other thermal sources.

Accordingly, the passive laser device 200 detects a fire. The mid-infrared sensor 210 detects a mid-infrared light emission signal from a fire source. The processing device 260 is configured to: (a) receive the mid-infrared light emission detected by said mid-infrared sensor; (b) determine a first mid-infrared light emission signal intensity at a first predetermined wavelength; (c) determine a second mid-infrared light emission signal intensity at a second predetermined wavelength; (d) determine concentration and temperature of the hot gasses from the first and second mid-infrared light emission signal intensities; and (e) determine a modified combustion efficiency of the fire source based on the ratio of first and second signal intensities.

### Combustion and Fire Modelling

Combustion and Fire research is motivated by the premise that the development of efficient and accurate codes for modelling these complex processes will impact diverse areas ranging from the deployment of more efficient and cleaner combustion devices for energy production to the predictive assessment of wildfire intensity and spread. In fact, for all but the simplest (and generally laminar) flame geometries, treatment of both detailed chemistry and fluid mechanics remains outside the practical limitations of current computational resources. In response to this antilogy, combustion researchers have employed strategies to simplify either the chemistry (often using reduced chemical mechanisms), the fluid mechanics, or both.

For turbulent, non-premixed flames, situated somewhere between the minimalist approaches to either fluid mechanics or chemistry, lies the application of conserved scalar relationships. At its core is the assumption that chemistry occurs on a much shorter time scale than do either diffusive or convective transport. If the chemistry were infinitely fast, it would be expected that the observed concentrations for species would be those predicted from an assumption of total equilibrium and therefore could be calculated solely from the local stoichiometry and temperature. For simple laminar names, such as those fuelled by hydrogen or hydrogen/carbon monoxide mixtures, this approach works pretty well. However, in turbulent flames of the same fuels, observed species concentrations depart from those calculated assuming adiabatic equilibrium. For hydrocarbon flames, the equilibrium predictions of concentrations in laminar flames are not realized. In particular, equilibrium predicts much higher levels for both carbon monoxide and molecular hydrogen than are actually observed. NOX levels are also poorly predicted. Thus, the equilibrium assumption is of little practical benefit in the prediction of emissions from practical combustion devices or wildfires.

Although local equilibrium is not realized in diffusion flames, at least one consequence of “fast” chemistry has been: in laminar flames many species' concentrations have been found to be functions of only the local stoichiometry. This observation has led to the broad use of conserved scalars as a basis of comparison of laminar flame results as well as in systems as large as wildfires. In some of these applications, a strong theoretical underpinning helps bolster confidence in the approach. However, in others, the tool's attraction is empirical and our enthusiasm for the simplification may mask discrepancies with other experimental results.

### Theoretical Background

Historically, stoichiometry has been used to correlate essential and fundamental properties of premixed flames—a premixed flame is one in which the fuel and the oxygen are mixed in advance of the combustion system. For example, flame temperature and burning velocity vary with equivalence ratio, φ, (the equivalence ratio is generally defined as the actual ratio of carbon atoms to oxygen atoms divided by the ratio of carbon atoms to oxygen atoms at the stoichiometric mixture; the equivalence ratio is less than one implies an excess of oxygen and greater than one, an excess of carbon) and for hydrocarbon fuels both reach their maximum value near φ=1.

In contrast to premixed flames, in diffusion flames the fuel and oxygen are physically separated and the flame burns when they diffused together to form a combustible mixture. Most practical energy producing flames our diffusion flames as are wildfires. In diffusion flames, the stoichiometry obviously depends on location and thus the overall stoichiometry has little meaning. Even so, it might be expected that fundamental quantities in diffusion flames would depend on the local chemical environment, and that is the case. In some older literature the local equivalence ratio has been used to track the local stoichiometry. However, this quantity is unbound and can vary from zero to infinity. An alternative approach to tracking local stoichiometry is defined below.

It is the collapse of species profiles when plotted against local stoichiometry that first attracted the attention of members of the turbulent combustion community looking for a way to simplify flame and fire structure calculations. (In his seminal work in the late 70s, Bilger showed two important results. First, it is possible to define quantities that are linear combinations of species concentrations that have no chemical source or sinks. Species conservation can then be simplified from a set of individual mass conservation equations for each of the species in a chemically reacting flow to just a single equation written for a conserved scalar.) For example, the mixture fraction, defined from the local mass fraction originating in fuel vs air entering the combustion system as

$$ξ = \frac{{m}_{f}}{{m}_{f} + {m}_{a}}$$

$$and$$

$$0 \leq ξ \leq 1$$

is often used to define local stoichiometry.

With libraries of the correlation of species concentrations and other important flame quantities such as the local heat release rate with mixture fraction, more complicated combustion and fire systems can now be approached through only the computational fluid mechanics, specifically concentrating on only the turbulent mixing.

The detailed information needed for these computationally efficient Conserved Scalar Libraries is generated through highly detailed, small-scale simulations and experimental measurements. Direct Numerical Simulation (DNS), which resolves all scales of turbulence and chemistry, is often used in simple, idealized laminar systems (non-turbulent flow) to generate a database of thermochemical states. Similarly, detailed experimental measurements in controlled laminar burners (like counterflow or co-flow flames) provide data on flame structure, temperature profiles, and species concentrations.

These detailed results, which incorporate complex, multi-step chemical reaction mechanisms, are then used to build the libraries by mapping the relationship between the conserved scalar values and the resulting temperature and species mass fractions. By effectively pre-calculating the detailed chemistry, these DNS and laminar system data allow the larger, turbulent fire models to more accurately represent complex combustion physics (like flame front location and temperature) on a much larger, practical scale without having to repeatedly solve the computationally intensive detailed chemical kinetics during the actual fire spread simulation.

An example in the wildfire arena is the NIST Fire Dynamic Simulator which is a computational fluid dynamics (CFD) model that has been used in a wide range of fire applications including wildland and Wildland-Urban Interface (WUI) fires. The code couples a gas-phase chemistry model based on mixture fraction) with models for the pyrolysis (thermal decomposition) of the solid fuel and radiative heat transfer. The heat released according to the conserved scalar model is what drives the pyrolysis of nearby unburned fuel, determining the fire spread rate.

Building Relevant Conserved Scalar Libraries for FOM measurements

As noted in our NSF proposal, our laboratory will demonstrate both Near Infrared (NIR) and Midinfrared (MIR) FOM technologies through studies in a diffusion flame supported on a Yale burner. This flame/burner system has been the object of several past investigations leading to a very complete understanding of its structure. From experimental and DNS results, conserved scalar relationships can be derived. However, to date, only chemistry for the elements carbon, oxygen, nitrogen, and hydrogen (CONH) has been included. This will be sufficient for the MIR measurements which focus on carbon monoxide and carbon dioxide, but will fall short for potassium chemistry. For the inclusion of potassium chemistry, we are pursuing two parallel paths. First, we are exploring the use of one-dimensional counterflow flame calculations with the CONH chemistry supplemented with relevant potassium flame chemistry to build conserved scalar libraries. New species added from in the potassium sub-mechanism can then be mapped onto existing DNS results for the Yale burner geometry.

A second approach is to build an axisymmetric, co-flow flame model using OpenFoam, a widely used and open source CFD environment which has been applied across a wide spectrum of problems. (For example, in addition to proprietary codes (such as from FLACS, Flaresim, Phast, or ANSYS Fluent), OpenFoam has been used to model industrial flares.) These results will lead directly to conserved scalar libraries.

### Relevance to K-FOM and CE-FOM

Potassium Fire Chemistry. Studies of potassium chemistry and fires has recently have recently expanded for several reasons. First, alkaline metals additions to flames have been studied to understand their role and both fire suppression and in their effect on molecular growth chemistry that leads to carbonaceous particulate matter. Secondly, there is increasing interest in the use of biofuels for energy production and thus a greater need 4 understanding it's overall impact on the combustion process. (For example, potassium may inhibit free radical concentrations which are responsible for propagating flames.)

Potassium in biological materials is typically present as an ion. However, the emission lines observed from fires near 770 nanometers are transitions from the 4p to the 4s levels of the neutral atom. This raises several important questions:

### The Role of Modified Combustion Efficiency (MCE)

The main target for the mid infrared CE-FOM sensor is the direct detection of carbon monoxide and carbon dioxide in flames and fires. From the relative intensity of multiple observed radiative emission peaks, the local temperature may be determined.

In both biomass burning (wildfire) and industrial flare emission characterization, a primary performance metric derived from CO and CO₂ concentrations is the Modified Combustion Efficiency (MCE):

$$MCE = \frac{Δ {CO}_{2}}{Δ {CO}_{2} + Δ CO}$$

Where Δ denotes the measured concentration above background levels.

MCE is a widely used proxy for the relative amount of flaming versus smoldering combustion:

High MCE (≈0.95 to 0.99): Indicates flaming combustion, which is hot, clean, and highly efficient at converting carbon in the fuel to CO₂.

Low MCE (≈0.65 to $0.85): Indicates smoldering combustion, which is slow, cool, and produces a large amount of incomplete combustion products like CO, CH₄, and particulate matter.

MCE Correlates with Other Emissions: Experimental data shows a strong correlation between MCE and the Emission Factors (EFs) for almost all other trace gases and aerosols. This means MCE effectively characterizes the chemistry of the plume.

Further, as CO and CO₂ may be correlated against mixture fraction, MCE may be derivable from conservative scalar libraries.

The system involves the construction of two laser heterodyne radiometers for laboratory demonstrations as well as simple “field-scale” demonstrations. The first system will operate in the near infrared and will focus on potassium detection. Because of the close technological connection with our lab's prior work and the ready availability of optoelectronics for this spectral region, this system will be the first constructed. The second system will proceed in two generations. In the first instance, a free space heterodyne unit will be constructed for operation at ~2200 cm-1 and will focus on detection of both carbon monoxide and carbon dioxide radiative emissions. This sensor is expected to provide directly flame temperature as well as a measure of combustion efficiency. In the second iteration, a source close to 2780 cm-1 will be used to explore radiative emissions from methane.

Task 1: Construction of Laser Heterodyne radiometers. In this opening task, sourcing of parts and construction for both a fiber-based NIR heterodyne unit and a free-space MIR Laser Heterodyne system will occur. Because parts for the former are readily available and technically nearly identical to ongoing atmospheric LHR work in our lab, this task is expected to be completed relatively quickly. Prices in the budget for the NIR system were quoted from Thorlabs and, at the time of writing, all were in stock for immediate delivery. Sourcing of components for the MIR unit represent greater challenges and a rapidly changing marketplace. For the purpose of budget development, Quantum Cascade (QC) and Interband Cascade (IC) laser prices were also budgeted from Thorlabs. However, new vendors for MIR sources are emerging (including MIRSense and Eblana Photonics, both of which we have approached in the development of this proposal.). Final decisions on sourcing these lasers will be made with both cost, availability, and suitability being weighed.

LHR also requires fast detection electronics, historically, not a characteristic of MIR detectors. Like the MIR sources, the MIR detector landscape is changing rapidly. Hamamatsu is now marketing a suitably fast detector (which is used here for budgeting). We have also discussed with MIR sense their potential marketing of quantum cascade detectors based on a similar, proprietary technology as used in their QC laser manufacture. Our latest heterodyne units have used NIR balanced detectors and that has dramatically improved their performance over our prior electronic designs. Vigo has introduced a balanced MIR detector, but at present its bandwidth is too small for practical LHR application. Development in this technology will also likely evolve.

An additional challenge in performing LHR in the MIR is in the mixing of thermal and laser radiation. In the NIR this is done with readily available, single mode optical fibers, (in some cases using polarization-maintaining fibers) and couplers. Although fibers are available in. the MIR, the range of options is limited. For example, a source for a 2×2 optical coupler as used in our NIR design, has not been located. An alternative that has been used in solar occultation LHR in the MIR is to mix on the detector using beam splitters to co-align the two radiation sources and this is the pathway we will pursue in this grant.

Task 2: Demonstration of TE-LHR: Diagnostics in steady and unsteady laboratory flames Task 2 will encompass the majority of the project duration and is divided into several subtasks.

Tasks 1b, 2b, and 3a: Potassium Spectral Radiometry

As noted above, potassium radiative emission detection represents a relatively high TRL for fire detection. In the laboratory, a simple system for demonstrating this can be through aspiration of a potassium salt into a hydrocarbon flame. An obvious test environment for these first studies would be an atomic absorption burner supporting a premixed flame (available in our laboratory). However, aspirations of saline solutions into a nonpremixed or partially premixed flames are also possible. The latter would provide a greater diversity in local stoichiometry and temperatures.

Referring to FIG. 5, a field-deployable system is shown for standoff characterization of biofuel fires. In the atmosphere, the potassium line at 769.9 nm is partially obscured by molecular oxygen, while the lower wavelength feature is not. Relevant to the technology proposed here, the ratio of the two lines combined with a model for atmospheric absorption along the path between observer and the fire would provide a “ranging” capability to the sensor. For the NIR heterodyne unit, we anticipate a system with a similar form factor to a system built by our laboratory and deployed in Alaska for monitoring carbon dioxide and methane emission from thawing permafrost. That system consisted of a “launch box” holding optical components connected through an umbilical carrying power, signal, and optical fibers to a carry-on sized Pelican case holding electronics.

Aspects of laboratory diagnostics. (a) The “Yale” burner equipped with a plenum to allow acoustically forced fuel flow rate. (b) Computed temperature profiles in response to forcing level.

Tasks 2a, 2d, and 2e: MIR Radiometry Laboratory Studies. Since the 1990s, several groups (including the GW group) have studied time-varying, flames burning in air formed by imposing a periodic fluctuation to the fuel flow rate of a steady flame. The fuels for these studies has included “neat” methane, or methane diluted with either nitrogen or air. If the fuel flow perturbation is sufficiently large, these flames are distinguished by the formation of axisymmetric, time dependent but periodic, large-scale, vortical structures caused by buoyancy-driven flow instabilities. Most of the measurements of flame species in time-dependent flames have been accomplished by in situ, laser-based methods that have determined concentrations of OH, CO, or soot itself. These results clearly indicate that particle growth and molecular emissions are greatly affected by the fuel flow perturbation. As noted by Smyth, enhanced soot formation in driven flames lies outside the range of physical space spanned by standard one-dimensional (counterflow) non-premixed (or partially premixed) flames. These results suggest that mildly turbulent flames such as would be expected from gas flaring (focus area 2) can be mimicked in the laboratory with these forced flames and a successful demonstration of the TE-LHR sensor here provides encouragement for its application to industrial flare diagnostics. Further, the acoustically forced flames that we will study have been identified as target flames by the International Sooting Flame Workshop and have substantial prior experimental and numerical simulation data, which are available for comparison and validation as shown in FIG. 4.

Our experiments will determine the sensitivity, time response, and the ability to characterize flame temperature and species concentrations using the contrast between emission and absorption spectral features (as shown above). Specifically, experiments will characterize TE-LHR performance using both stable and forced CH₄ flames from laboratory flames.

Task 2c. Laboratory Diagnostics: Confocal Imaging. Confocal imaging has become a standard technique for 3D imaging in microscopy for decades. In that application space, a tightly focused laser can be swept across a sample (in a plane defined by x, y) and focused at different depths in the sample by translation of the latter. Typically, light is collected through a pinhole which provides spatial filtering that eliminates collection of light not in the (desired) focal plane. In other implementations, single mode optical fibers can be used to replace the pinholes in confocal imaging. Confocal imaging has been used in combustion diagnostics, including in a study of NO LIF detection and in an application in which a precision of 30 μm was achieved at 2 standoff length in visualizing surface features through a fire. We feel that at the laboratory scale employing confocal imaging will provide sufficient spatial resolution to map out structural information within these axially symmetric, co-flow flames without tomographic reconstruction.

Task 3: Diagnostics in a controlled Bio-fire and toward a field-deployable Wildfire Sensor. A “field instrument” is provided that can be used for measurements in a model “wildfire” system. There will be two aspects of this Task. First, packaging of both NIR and MIR heterodyne units into suitable enclosures will be required. As noted above, the NIR system packaging should proceed fairly simply as the technology will be a merging of both an Open path TDALS system developed by us and nearly identical optoelectronics to those used in the earlier NASA-based or the later DoE-funded LHR systems. For the MIR system, we will begin with a design similar to one used in a recent NASA SBIR project by Mesa Photonics and funded by NASA which explored MIR LHR near 3.6 μm. (PI Miller served as a consultant for this Phase I project.) The goal for both NIR (using fiber mixing) and MIR. (using free space mixing) systems is a system that will fit onto a ~300×300 breadboard. The enclosed optical system will be mounted onto an azimuth-altitude telescope mount for “aiming” to a target thermal source.

The system is a small, stainless steel backyard fire pit such as those made by Solo. The fires burning in these stoves is estimated to be in the range of 10-50 kW, but they can also be used to study smoldering combustion. These measurements will be valuable in assessing the potential for the potassium emission discrimination between cool and hotter combustion environments, the measurements of temperature and estimates of combustion efficiencies near 4.6 μm, and the emission of volatile organic compounds and methane from smoldering combustion near 3.6 μm.

The relevance of these measurements is paramount. The transition of surface fires to crown fires is important to detect as it determines the appropriate fire-fighting technology required. This transition is difficult to determine from space at the time and spatial resolution, and standoff detection from ground-based sensors could provide critical data to first responders.

Referring to FIG. 4, Molecular Radiation is shown. Preliminary results and modelled spectra. FIG. 4A shows FTIR spectra of flame emission collected from ~25 mm HAB and centered radially from a 60% C2H4/40% N2 non-premixed flame collected on the “Yale burner” with a spectral resolution of 0.125 cm-1. Regions of dominant emission intensity are labelled with the presumed molecular sources, FIG. 4B Red trace: high resolution portion of the spectrum in FIG. 4A near 2200 cm-1 showing emission lines from both CO* and CO²*. The blue trace: shows the same spectral region at 0.5 cm-1 resolution. Temperature can be determined by taking the ratio of line pairs (such as the two CO* lines indicated or, with better precision, modelling a multi-line spectrum. Temperature determination from an FTIR spectrum is challenged by not only the lower spectral resolution, but also the convolution of the Michelsen line shape function imposed in the interferometry. FIG. 4C shows simulated Lahetra spectrum near that shown in (b) using LahetraSim software calculated at 0.001 cm-1, near the practical limit of current heterodyne receivers. FIG. 4D shows simulated molecular radiative emission from a mixture of 10% CH₄ (orange), 10% H₂O (green), and 1% H₂CO (blue) simulating a flare at 1700 K and 1 atm. The summed emission spectra are shown in gray.

For this system, emission spectra and gas temperatures can be simulated using the HITRAN and HITEMP databases via the HITRAN Application Interface (HAPI). An example calculated spectrum, FIG. 4C, centered at 4.548 μm (2199 cm-1), shows hot CO flame emission (peaks) and absorption by CO₂ in the atmosphere along a 1 km path from flare to sensor (valleys). Emission lines are narrow because linewidths (in nearly all cases) are linearly proportional to molecular collision rates. Molecular number densities are inversely proportional to temperature (the ideal gas law) and molecular speeds increase as the square root of temperature. The two opposite effects combine so that collision frequencies and spectroscopic linewidths scale as T^{-1/2}. FIG. 4D shows another simulated spectrum centered at 3.597 μm which shows features expected in both wildfires and flares from hot methane, water, and formaldehyde. Because this spectral region is much more crowded, deconvolution through summing contributions from each molecule is required, similar to our prior work looking at formaldehyde and methane absorption in gases sampled from analogous flame systems.

As noted in the introduction, wildfires, as a response to and a cause of climate warming, are an increasing global threat. The total burned area during “fire seasons” has gone from ~1000 square miles in the last two decades of the last century to over ~2500 square miles in the last 20 years. This has come with great cost for suppression which have increased 600% over that same time interval and the economic costs have grown even faster ($30M in the 1980s to $1B currently). Independent of our goal of dramatically reducing fossil fuel combustion, increasing wildfire severity is expected to be the new normal for centuries. In the arctic, the problem is more severe as the boreal biome shifts from being a carbon sink to a carbon source. NASA's FireSense program emphasizes real-time observation and characterization of wildfires as a priority focus. Further, as discussed above, satellite characterization of fires is limited by daylight, clouds, spectral, spatial, and temporal resolution. Thus, a clear need for “ground truthing” that can fill in data voids and provide real-time data to first responders.

A second “use case” for this technology is in the characterisation of industrial flares. As with wildfires, satellite measurements of emitted light do not explicitly provide chemical information, such as amounts of unburnt fuel or concentrations of higher molecular weight compounds. Satellite measurements are possible only at night when sunlight does not overwhelm thermal emission signatures and can be obscured by clouds. Further, some emitted infrared light is absorbed in the atmospheric column and might skew results. Ground based thermal imagers may detect fugitive, hot CH4 but the images are dominated by soot thermal emissions. The LaHetRa sensors can provide feedback for flare control to maintain stability and minimize emissions of CH4, higher hydrocarbons, and soot.

Our experimental work followed two paths. We have mapped out Angstrom Coefficients (or Angstrom Exponent) in a target flame. Our results show that this quantity (which is the power law exponent for the dependence of extinction on wavelength, generally taken to be 1 for “black” carbon) varies in the flame, with higher values observed in fuel-rich flame regions of the diffusion flame. Researchers studying radiative properties of carbon in the atmosphere have observed Angstrom Coefficients magnitude exceeding “1” (i.e., a faster fall off in extinction with increasing wavelength) for “Brown” Carbon, thought to be particulate with a larger organic content. In the case of these flames, we hypothesize that greater Angstrom Coefficients correlate with greater PAH content (or at least incorporation of smaller-sized PAH into the soot structure). In our work, we have performed an analysis of the “Angstrom Coefficient” by measuring extinction of light in flames throughout the visible as well as the near infrared (up to 2 micrometers) using a supercontinuum source. We have also made complementary measurements with an external cavity, interband cascade laser near 3 micrometers. On-going work in the laboratory is extending these measurements through the ultraviolet using a pulsed, OPO system.

Low fluence, laser desorption/ionization followed by high resolution, imaging mass spectrometry was used to analyze particulate carbon thermophoretically sampled from a 60% ethylene in nitrogen-fueled, co-axial diffusion flame was investigated in this work, where the fuel/nitrogen mixture enters from a central fuel nozzle surrounded by a concentric flow of air. This flame system has been studied extensively by our group and others using several experimental techniques, including laser induced incandescence (LII), TEM, Raman spectroscopy, and light extinction, along with corresponding computational models. This analysis revealed that PAHs of 239-838 Da, containing few oxygenated species, comprise the soot observed in an ethylene diffusion flame. As informed by chemical graph theory (CGT), the vast majority of species observed in the sampled particulate matter are fully benzenoid, consisting of only fused 6-membered rings. There is clear evidence for the presence of radical PAHs in the particulate samples. Further, the observed empirical formulae limit the observed isomers to those which are nearly circular with high aromatic conjugation lengths for a given aromatic ring count. These results stand in contrast to recent reports that suggest higher aliphatic composition of primary particles.

Related activities undertaken in the grant included participation on a manuscript on Soot and Black Carbon Nomenclature. A publication is nearing submission entitled “Differentiation of pine and oil-based soots in East Asian inks using Raman spectroscopy” by Jennifer Giaccai of the National Museum of Asian Art, Smithsonian Institution and PI Miller.

An outreach project associated with this grant involved engaging citizen scientists and students in awareness of carbon in the environment. Specifically, we designed and deployed several “Luftsinn” sensors that report carbon dioxide and meteorological data to the web. Some of these sensors were used in the District of Columbia PA2040 smart city initiative and others were deployed in DC public schools. A new version of the sensors (LuftSinn II) incorporates inexpensive PM2.5 sensors and are being prepared for another deployment in DC public schools.

In addition to the embodiments shown and described, the system and method of the disclosure can be implemented by a computer or computing device having a processor, processing device or controller to perform various functions and operations in accordance with the disclosure. The computer can be, for instance, a personal computer (PC), server or mainframe computer. The processor may also be provided with one or more of a wide variety of components or subsystems including, for example, a co-processor, register, data processing devices and subsystems, wired or wireless communication links, input devices, monitors, memory or storage devices such as a database. All or parts of the system and processes can be stored on or read from computer-readable media. The system can include computer-readable medium, such as a hard disk, having stored thereon machine executable instructions for performing the processes described. All or parts of the system, processes, and/or data utilized in the disclosure can be stored on or read from the storage device(s). The storage device(s) can have stored thereon machine executable instructions for performing the processes of the disclosure. The processing device can execute software that can be stored on the storage device. Unless indicated otherwise, the process is preferably implemented automatically by the processor substantially in real time without delay and without manual interaction.

As used herein, when an element or feature is described as being “configured,” that element or feature is structurally arranged or formed to accomplish the stated purpose. As used with respect to a processing device (e.g., computer), the term “configured” includes that the processing device is structurally arranged or ordered (e.g., by supplying, arranging or connecting a specific set of internal or external components or modules, for example that perform certain operations) to accomplish the stated purpose or task.

The foregoing description and drawings should be considered as illustrative only of the principles of the disclosure, which may be configured in a variety of shapes and sizes and is not intended to be limited by the embodiment herein described. Numerous applications of the disclosure will readily occur to those skilled in the art. Therefore, it is not desired to limit the disclosure to the specific examples disclosed or the exact construction and operation shown and described. Rather, all suitable modifications and equivalents may be resorted to, falling within the scope of the disclosure.

1. A passive laser device for detecting a fire, said device comprising:
a near-infrared sensor configured to detect a near-infrared light emission signal from a fire source; and
a processing device configured to:
receive the near-infrared light emission detected by said near-infrared sensor;
determine a near-infrared light emission signal intensity at a predetermined wavelength; and
determine a fire source type of the fire source based on the near-infrared light emission signal intensity.

2. The device of claim 1, said processing device further configured to determine that the fire source is a biological fire when the near-infrared light emission signal intensity is above a threshold and that the fire source is a fossil fuel fire when the near-infrared light emission signal intensity is below the threshold.

3. The device of claim 1, wherein spectral peak intensity at longer wavelengths are obscured by light absorption by molecular oxygen in the atmosphere.

4. The device of claim 1, said processing device further configured to determine a distance of said sensor from the fire source based on the intensity ratio.

5. The device of claim 1, further comprising a sensor housing enclosing said sensor, and wherein said sensor housing is passive so that light never leaves said sensor housing to be eye safe.

6-11. (canceled)

12. The device of claim 1, wherein the near-infrared light emissions are between 765-770 nm.

13. The device of claim 1, said two near-infrared light emission signals comprise a first near-infrared light emission signal having a first spectral peak wavelength with a first spectral peak intensity and a second near-infrared light emission signal having a second spectral peak wavelength with a second spectral peak intensity.

14. The device of claim 13, wherein the temperature of the fire is determined based on a comparison of the first and second spectral peak intensities.

15. (canceled)

16. A passive laser device for detecting a fire, said device comprising:
a near-infrared sensor configured to detect a near-infrared light emission signal from a fire source; and
a processing device configured to:
receive the near-infrared light emission detected by said near-infrared sensor;
determine a first near-infrared light emission signal intensity at a first predetermined wavelength;
determine a second near-infrared light emission signal intensity at a second predetermined wavelength; and
determine an intensity ratio of the first and second near-infrared light emission signal intensities;
determine a characteristic of the fire source based on the intensity ratio.

17. The device of 16, wherein the characteristic comprises one of temperature or distance to the fire source.

18. The device of 17, wherein the temperature and distance to the fire source are directly related to the intensity ratio.

19. The device of claim 16, wherein the first and second near-infrared light emission signals indicate the presence of potassium in the near-infrared light emission signal from the fire source.

20. A passive laser device for detecting a wildfire, said device comprising:
a mid-infrared sensor configured to detect mid-infrared light emission signals from a fire source; and
a processing device configured to receive mid-infrared light emission signals detected by said mid-infrared sensor, determine temperatures and concentration of hot gasses, and determine the combustion efficiency of the fire source based on the concentration of hot gasses.

21. The device of claim 20, wherein mid-infrared light emissions have less interference from broadband radiative emission signals, enabling robust detection of molecular signatures.

22. The device of claim 20, further comprising a sensor housing enclosing said sensor, and wherein said sensor housing is passive so that light never leaves said sensor housing to be eye safe.

23-24. (canceled)

25. The device of claim 23, wherein the spectral resolution improves selectivity and sensitivity for targeted atoms and molecules.

26. The device of claim 23, wherein the spectral resolution allows for extracting additional physical data that impacts the shapes of highly resolved spectral features.

27. The device of claim 20, wherein said device utilizes optoelectronics resulting in rugged, field deployable, and stand-off instruments.

28-34. (canceled)

35. The device of claim 16, further comprising:
a fiber combiner configured to combine light emission signals and the laser signal to provide a combined signal;
a balanced detector configured to remove noise from the combined signal and provide a combined electrical power signal output; and
a power sensor configured to measure power of a heterodyne beat signal within a defined frequency band, and provide a measured output proportional to the electrical signal power output.

36. The device of claim 3416, further comprising:
a first optical component configured to receive the light emission signals;
a second optical component configured to receive the laser signal;
a beam splitter configured to receive the light emission signals from said first optical component and the laser signal from said second optical component, to provide a combined optical signal;
a photodetector configured to receive the combined optical signal from said beam splitter and provide an electrical signal output;
a DC block configured to receive the electrical signal output and remove DC components from the electrical signal output, passing only a RF heterodyne signal; and
a processing device configured to extract emission characteristics from the RF heterodyne signal.
